(19) United States
(12) Patent Application Publication
(10) Pub. No.: US 2004/0092637 A1
(43) Pub. Date: May 13, 2004

(54) Electronic display of automotive colors

(75) Inventor: Craig J. McClanahan, Bowling Green, OH (US)

Correspondence Address: BASF CORPORATION, ANNE GERRY SABOURIN, 26701 TELEGRAPH ROAD, SOUTHFIELD, MI, 48034-2442, US

(73) Assignee: BASF Corporation, Mount Olive, NJ (US)

(21) Appl. No.: 10/065,705

(22) Filed: Nov. 12, 2002

(51) Int. Cl. B05D 1/36; C08K 3/32; C08K 3/10; C08K 3/18

(52) U.S. Cl. 524/406; 427/402; 524/417; 524/432

(57) ABSTRACT

The invention provides a coating composition for use with metallic substrates that provides desirable levels of adhesion to metal, sandability without the production of harmful dust, corrosion resistance, and recoatability. The coating composition of the invention comprises a polyurethane film-forming component, and a corrosion protection component present in the composition in an amount effective in minimizing corrosion and adhesion loss of the coating at the substrate. A cured film of the coating applied to metallic substrates, previously coated substrates, as well as plastic substrates has improved corrosion resistance following Salt Spray Cabinet exposure.

### BACKGROUND OF INVENTION

As used herein, “automotive refinish ” refers to compositions and processes used in the repair of a damaged automotive finish, usually an OEM provided finish. Refinish operations may involve the repair of one or more outer coating layers, the repair or replacement of entire automotive body components, or a combination of both. The terms “refinish coating” or “repair coating” may be used interchangeably.

Automotive refinishers must be prepared to paint a wide variety of materials. Examples of commonly encountered materials are one or more previously applied coatings, metal substrates such as aluminum, galvanized steel, and cold rolled steel. Bare metal substrates are often exposed as a result of the removal of the previously applied coating layers containing and/or surrounding the defect area. However, it is often difficult to obtain adequate corrosion resistance of refinish coatings applied to substrates.

In particular, to provide desirable salt spray resistance, polyurethane films have typically relied upon the use of corrosion protection components containing heavy metal pigments such as strontium chromate, lead silica chromate, and the like. Unfortunately, sanding such a film produces dust that is environmentally disfavored due to the presence of the heavy metal containing pigments. Since sanding is a necessity for automotive refinish primers, this disadvantage can render the coating unusable in most commercial refinish application facilities. Accordingly, it would be advantageous to provide a coating which can provide adequate salt spray resistance but which is substantially free of any heavy metal containing pigments.

Accordingly, it would be desirable to provide refinish coatings having good adhesion to bare metal substrates lacking any pretreatment or surrounding coating and that provides good corrosion resistance.

### SUMMARY OF INVENTION

The above stated objects of the invention are achieved with the use of the compositions of the invention. It has unexpectedly been found that a coating composition comprising the following demonstrates good adhesion to bare metal substrates and improved corrosion-resistance, in comparison to similar coating compositions. The composition of the invention is a two-component coating composition.

The invention broadly provides a coating composition comprising a two component coating composition comprising a film-forming component comprising a) a film-forming polymer and a crosslinking agent, b) a corrosion protection component, and c) composition comprising (I) the reaction product of (la) at least one difunctional carboxylic acid, (Ib) at least one trifunctional polyol, (Ic) at least one chain stopper, and (Id) phosphoric acid, and (II) a second compound comprising one or more carboxy phosphate esters, wherein said coating demonstrates at least a 20% reduction in salt spray corrosion over the same coating without components (b) and (c).

### DETAILED DESCRIPTION

The composition of the invention is a two-component coating composition. As used herein, the term “two-component” refers to the number of solutions and/or dispersions, which are mixed together to provide a curable coating composition. Up to the point of mixing, neither of the individual components alone provides a curable coating composition.

Once mixed, the resulting curable coating composition is applied to a substrate as quickly as possible. Typically, “as quickly as possible” means immediately after the mixing of the separate components or within eight (8) hours from the time the separate components are mixed, preferably less than one (1) hour after mixing. In a typical two-component application process the components are mixed together either (I) at the nozzle of a sprayer by the joining of two separate carrier lines at the nozzle or (II) immediately upstream of the nozzle of a sprayer and then delivered to the nozzle via a single carrier line.

Once at the nozzle, the mixture is immediately atomized into a mist that is directed at a substrate, which is being coated with a film of the admixture of the two-components.

Unlike one-component compositions, two-component compositions will generally cure in the absence of elevated temperatures. The individual components of the film forming polymer and crosslinking agent will react with each other upon admixture to provide a crosslinked product, most often at ambient temperatures, or more particularly at temperatures of from 15 to 60° C. (59 F.-140° F.) and most preferably from 24 to 60° C. (75.2° F. -140° F.).

As used throughout the application, ranges for any value are used as shorthand for describing each and every value that is within the range. Any value within the range can be selected as the terminus of the range.

The two component coating composition of the present invention includes a film-forming component comprising a film-forming polymer and a crosslinking agent, wherein the film-forming polymer has functional groups selected from the group consisting of active hydrogen containing groups, epoxide groups, and mixtures thereof, and the crosslinking agent have functional groups selected from the group consisting of isocyanate groups and amine groups.

The coating additionally includes a corrosion protection component consisting essentially of compounds selected from the group consisting of zinc oxide, zinc phosphate, basic zinc phosphate, zinc nitrophophthalate, zinc molybdate, basic zinc phosphate hydrate, basic zinc molybdate, zinc benzoate and zinc salt of an organic nitro compound such as those sold under the trademark Heucorin RZ, (2-benzothiazolythio)-succinic amine salt sold under the trademark Irgacor 153, calcium molybdate, calcium metaborate, barium metaborate, calcium strontium phosphosilicate, aluminum triphosphate, aluminum zinc phosphate, zinc calcium aluminum strontium polyphosphate silicate and strontium aluminum polyphosphate, calcium aluminum strontium polyphosphate silicate hydrate, modified strontium aluminum polyphoshate hydrate and mixtures thereof.

The coating additionally includes a composition comprising (I) a first compound having an acid number of from 70 to 120 mg KOH/g, a hydroxyl number of from 200 to 400 mg KOH/g, a number average molecular weight of from 150 to 3000, and which is the reaction product of (a) at least one difunctional carboxylic acid, (b) at least one trifunctional polyol, (c) at least one chain stopper, and (d) phosphoric acid, and

(II) a second compound comprising one or more carboxy phosphate esters having the formula: (R—O)_{X}—P(O)—(OM)_{3-X}

wherein R is an C₅-C₄₀ aliphatic group in which one or more aliphatic carbon atoms are substituted with lateral or terminal —COOR¹ groups, wherein R¹ is H, metal, ammonium, C₁-C₆ alkyl, or C₆-C₁₀ aryl, M is hydrogen, metal or ammonium, and x is a number from 0 to 3.

Coating compositions of the invention may comprise any of the film-forming components used in the refinish coatings industry. Such coating compositions may rely on air-dry lacquer film formation, film formation via chemical crosslinking, or a combination thereof. Thermosetting films produced by chemical crosslinking are most preferred.

Thermosetting coatings of the invention will comprise at least one film-forming polymer and at least one crosslinking agent. The film-forming polymer will comprise one or more functional groups reactive with one or more functional groups on the crosslinking agent. Examples of functional group combinations useful for the production of crosslinked coatings include, but are not limited to, active-hydrogen and isocyanate, epoxide and carboxylic acid, hydroxyl/carboxylic acid and/or urea-formaldehyde/melamine-formaldehyde, epoxide and amine, and the like.

Although the film-forming polymer may contain any functional group reactive with the functional group present on the crosslinking agent, preferably the functional group present on the film-forming polymer is at least one functional group selected from the group consisting of hydroxyl, amine, carboxylic acid, epoxy and mixtures thereof. Especially preferred functional groups for use on the film-forming polymer are hydroxyl groups and amine groups, with hydroxyl groups being most preferred.

Examples of suitable film-forming polymers are acrylic polymers, polyurethane polymers, polyesters, alkyds, polyamides, epoxy group containing polymers, and the like.

Particularly preferred film-forming polymers will be difunctional, generally having an average functionality of about two to eight, preferably about two to four. These compounds generally have a number average molecular weight of from about 400 to about 10,000, preferably from 400 to about 8,000. However, it is also possible to use low molecular weight compounds having molecular weights below 400. The only requirement is that the compounds used as film-forming polymers not be volatile under the heating conditions, if any, used to cure the compositions.

More preferred compounds containing reactive hydrogen groups are the known polyester polyols, polyether polyols, polyhydroxyl polyacrylates, polycarbonates containing hydroxyl groups, and mixtures thereof. In addition to these preferred polyhydroxyl compounds, it is also possible to use polyhydroxy polyacetals, polyhydroxy polyester amides, polythioether containing terminal hydroxyl groups or sulphydryl groups or at least difunctional compounds containing amino groups, thiol groups or carboxy groups. Mixtures of the compounds containing reactive hydrogen groups may also be used.

In a most preferred embodiment of the invention, the film-forming polymer reactable with the crosslinking agent is an acrylic resin, which may be a polymer or oligomer. The acrylic polymer or oligomer preferably has a number average molecular weight of 500 to 1,000,000, and more preferably of 1000 to 20,000. Acrylic polymers and oligomers are well-known in the art, and can be prepared from monomers such as methyl acrylate, acrylic acid, methacrylic acid, methyl methacrylate, butyl methacrylate, cyclohexyl methacrylate, and the like. The active hydrogen functional group, e.g., hydroxyl, can be incorporated into the ester portion of the acrylic monomer. For example, hydroxy-functional acrylic monomers that can be used to form such resins include hydroxyethyl acrylate, hydroxybutyl acrylate, hydroxybutyl methacrylate, hydroxypropyl acrylate, and the like. Amino-functional acrylic monomers would include t-butylaminoethyl methacrylate and t-butylamino-ethylacrylate. Other acrylic monomers having active hydrogen functional groups in the ester portion of the monomer are also within the skill of the art.

Modified acrylics can also be used. Such acrylics may be polyester-modified acrylics or polyurethane-modified acrylics, as is well known in the art. Polyester-modified acrylics modified with e-caprolactone are described in U.S. Pat. No. 4,546,046 of Etzell et al, the disclosure of which is incorporated herein by reference.

Polyurethane-modified acrylics are also well known in the art. These are described, for example, in U.S. Pat. No. 4,584,354, the disclosure of which is incorporated herein by reference.

Polyesters having active hydrogen groups such as hydroxyl groups can also be used as the film-forming polymer in the composition according to the invention. Such polyesters are well known in the art, and may be prepared by the polyesterification of organic polycarboxylic acids (e.g., phthalic acid, hexahydrophthalic acid, adipic acid, maleic acid) or their anhydrides with organic polyols containing primary or secondary hydroxyl groups (e.g., ethylene glycol, butylene glycol, neopentyl glycol).

Polyurethanes having active hydrogen functional groups are also well known in the art. These are prepared by a chain extension reaction of a polyisocyanate (e.g., hexamethylene diisocyanate, isophorone diisocyanate, MDI, etc.) and a polyol (e.g., 1,6-hexanediol, 1,4-butanediol, neopentyl glycol, trimethylol propane). These can be provided with active hydrogen functional groups by capping the polyurethane chain with an excess of diol, polyamine, amino alcohol, or the like.

Although polymeric or oligomeric active hydrogen components are often preferred, lower molecular weight non-polymeric active hydrogen components may also be used in some applications, for example aliphatic polyols (e.g., 1,6-hexane diol), hydroxylamines (e.g., monobutanolamine), and the like.

Examples of suitable crosslinking agents include those compounds having one or more functional groups reactive with the functional groups of the film-forming polymer. Examples of suitable crosslinking agents include isocyanate functional compounds and aminoplast resins, epoxy functional compounds, acid functional compounds and the like. Most preferred crosslinkers for use in the coating compositions of the invention are isocyanate functional compounds.

Suitable isocyanate functional compounds include polyisocyanates that are aliphatic, including cycloaliphatic polyisocyanates, or aromatic. Useful aliphatic polyisocyanates include aliphatic diisocyanates such as ethylene diisocyanate, 1,2-diisocyanatopropane, 1,3-diisocyanatopropane, 1,6-diisocyanatohexane, 1,4-butylene diisocyanate, lysine diisocyanate, hexamethylene diisocyanate (HDI), 1,4-methylene bis-(cyclohexylisocyanate) and isophorone diisocyanate. Useful aromatic diisocyanates include the various isomers of toluene diisocyanate, meta-xylenediioscyanate and para-xylenediisocyanate, also 4-chloro-1,3-phenylene diisocyanate, 1,5-tetrahydro-naphthalene diisocyanate, 4,4′-dibenzyl diisocyanate and 1,2,4-benzene triisocyanate can be used. In addition, the various isomers of α, α, α′, α.′-tetramethyl xylene diisocyanate can be used.

In a most preferred embodiment, the crosslinking agent will comprise one or more components selected from the group consisting of hexamethylene diisocyanate (HDI), the isocyanurates of HDI, the biurets of HDI, and mixtures thereof, with the isocyanurates and biurets of HDI being particularly preferred.

Suitable isocyanate functional compounds may be unblocked, in which case the coating composition should be utilized as a two-component system, i.e., the reactive components combined shortly before application, or may be blocked. Any known blocking agents, such as alcohols or oximes, may be used.

Although the composition may contain other filler and/or extender pigments such as talc, barrites, silicas and the like, such are not generally considered to substantially contribute to the salt spray resistance of cured films made from the coating compositions of the invention.

In general, the corrosion protection component of the invention will be present in an amount of from 0.011 to 0.051, more preferably 0.015 to 0.045, and most preferably from 0.025 to 0.040, all being based on P/B, i.e., the % by weight based on the total nonvolatile of the film-forming component, which is the total nonvolatile weight of the film-forming polymer and the crosslinking agent.

The coating of the invention requires the use of a composition comprising a mixture of a first compound (I) and a second compound (II), wherein compound (I) and compound (II) cannot be the same. It has unexpectedly been found that the combination of compounds (I) and (II) provides an improvement in refinish adhesion, i.e., the adhesion of a refinish coating to a bare exposed metal substrate, which is better than that obtained with the use of either compound (I) or compound (II) alone or in coatings without the composition comprising (I) and (II).

Compound (I) is a low molecular weight polyester compound having both acid and hydroxyl functionality. It will generally have a number average molecular weight in the range of from 150 to 3000, preferably from 300 to 1000, and most preferably from 400 to 600. Compound (I) will generally have a polydispersity of from 1.00 to 2.00, with a polydispersity of 1.50 being most preferred.

Suitable compounds (I) will also have an acid number in the range of from 70 to 120 mg KOH/g, preferably from 70 to 100 mg KOH/g, and most preferably from 70 to 80 mg KOH/g.

In addition, suitable compounds (I) will have a hydroxyl number in the range of from 200 to 400 mg KOH/g, more preferably from 300 to 400 mg KOH/g and most preferably from 330 to 360 mg KOH/g.

Compound (I) generally comprises the reaction product of the reaction of (a) at least one difunctional carboxylic acid, (b) at least one trifunctional polyol, (c) at least one chain stopper, and (d) phosphoric acid.

Examples of suitable difunctional carboxylic acids (a) include adipic acid, azeleic acid, fumaric acid, phthalic acid, sebacic acid, maleic acid, succinic acid, isophthalic acid, tetrahydrophthalic acid, hexahydrophthalic acid, dimer fatty acids, itaconic acid, glutaric acid, cyclohexanedicarboxylic acid, and mixtures thereof. Preferred difunctional carboxylic acids (a) are adipic acid and azeleic acid. Adipic acid is most preferred for use as difunctional carboxylic acid (a).

The at least one trifunctional polyol (b) may be branched or unbranched, but branched trifunctional polyols are preferred. Examples of suitable trifunctional polyols (b) are trimethylolpropane, trimethylol ethane, glycerin, 1,2,4-butanetriol, and mixtures thereof. Preferred trifunctional polyols (b) are trimethylolpropane and trimethylol ethane, with trimethylolpropane being a most preferred trifunctional polyol (b).

The at least one chain stopper will generally be a carboxylic acid that is different from the at least one difunctional carboxylic acid (a). Monocarboxylic acids are preferred. Suitable carboxylic acids (c) will preferably contain one or more aromatic structures and will preferably contain some branched alkyl groups. Examples of suitable carboxylic acids (c) include para-t-butyl benzoic acid, benzoic acid, salicylic acid, 2-ethylhexanoic acid, pelargonic acid, isononanoic acid, C₁₈fatty acids, stearic acid, lauric acid, palmitic acid, and mixtures thereof. Preferred carboxylic acids (c) include para-t-butyl benzoic acid, benzoic acid, and 2-ethylhexanoic acid, with para-t-butyl benzoic acid being most preferred.

Phosphoric acid (d) should be added to the reaction mixture in an amount of from 0.03 to 0.20, preferably from 0.05 to 0.15, and most preferably from 0.07 to 0.10. It will be appreciated that while phosphoric acid is most preferred, phosphate esters such as butyl or phenyl acid phosphate and the like are suitable for use as component (d) in the preparation of compound (I).

Polymerization of the reactants may occur at typical esterification conditions, i.e., 200-230° C. reaction temperature while continuously removing water as a reaction by-product. Solvents that facilitate the removal of water from the reaction system (those that form an azeotrope) such as xylenes, may be used.

Reactants (a), (b), (c) and (d) will generally be used in a molar ratio of 4.2: 4.9: 0.01:0.0005 to 5.1:5.6:0.7:0.005, preferably from 4.4: 5.0:0.02:0.0008 to 5.0:5.5:0.6:0.003, and most preferably from 4.8:5.2:0.02:0.0009 to 4.9:5.4:0.06:0.002.

A commercially available and most preferred example of compound (I) is Borchigen HMP, commercially available from the Wolff Walsrode division of the Bayer Corporation of Burr Ridge, Ill., U.S.A.

Compound (II) comprises a carboxy phosphate ester having the formula: (R—O)_{X}—P(O)—(OM)_{3-X}

wherein M is hydrogen, metal or ammonium, x is a number from 0 to 3, and R is a saturated or unsaturated C₅-C₄₀ aliphatic group in which one or more of the aliphatic carbon atoms can be substituted or replaced with a halogen atom (such as fluorine or chlorine), a C₁-C₆ alkyl group, a C₁-C₆ alkoxy group, a C₆-C₁₀ aromatic hydrocarbon group, preferably phenyl or naphthyl, or a C₆-C₁₀ aromatic hydrocarbon group that is substituted with one or more (preferably 1 to 3) C₁-C₆ alkyl groups or —COOR¹ groups wherein R¹ is H, metal, ammonium, C₁-C₆ alkyl, or C₆-C₁₀ aryl, or mixtures thereof.

In preferred compounds (II), R will contain one or more C₆-C₁₀ aromatic hydrocarbon groups, and most preferably, one or more C₆-C₁₀ aromatic hydrocarbon groups which contain one or more, preferably at least two, —COOR¹ groups wherein R¹ is H, metal, ammonium, C₁-C₆ alkyl, or C₆-C₁₀ aryl.

In a most preferred compound (II), R will contain at least one C₆-C₁₀ aromatic hydrocarbon group and at least two —COOR¹ groups wherein R¹ is H, metal, ammonium, C₁ -C₆ alkyl or C₆-C₁₀ aryl. R¹ will most preferably be a C₁-C₆ alkyl or a C₆-C₁₀ aryl group.

The —COOR¹ groups may be lateral or terminal. It will be appreciated that when R¹ is H, compound (II) will comprise one or more free carboxylic acid groups. Similarly, when R¹ is a metal or ammonium ion, compound (II) will have one or more carboxylic acid salt groups.

Finally, when R¹ is a C₁-C₆ alkyl or a C₆-C₁₀ aryl, compound (II) will comprise one or more ester groups.

It will be appreciated that suitable compounds (II) can and most preferably will comprise mixtures of compounds having the formula: (R—O)_{X}—P(O)—(OM)_{3-X}

wherein R, M, x, and R¹ are as described above. However, in a most preferred embodiment, such a mixture will contain one or more molecules having the above structure wherein x is 1 or 2, preferably 1, R has at least one C₆-C₁₀aromatic hydrocarbon group substituted with at least one, preferably two, —COOR¹ groups wherein R¹ is H or a C₁-C₆ alkyl or C₆-C₁₀ aryl, most preferably a C₁-C₆ alkyl, and M is H.

Compound (II) will generally have a number average molecular weight in the range of from 600 to 1200, preferably from 700 to 900, and most preferably from 750 to 850. Compound (II) will generally have a polydispersity of from 1.00 to 2.00, with a polydispersity of 1.00 to 1.50 being preferred and a polydispersity of 1.1 5 to 1.35 being most preferred.

Suitable compounds (II) will also have an acid number in the range of from 50 to 200 mg KOH/g, preferably from 100to 180 mg KOH/g, and most preferably from 120 to 160 mg KOH/g. In addition, suitable compounds (II) will have a hydroxyl number in the range of from 100 to 250 mg KOH/g, preferably from 120 to 230 mg KOH/g, and most preferably from 150 to 200 mg KOH/g.

Suitable compounds (II) generally comprise the reaction product of (a) at least one difunctional polyol, (b) phosphoric acid, and (c) at least one trifunctional carboxylic acid.

Examples of suitable difunctional polyols (a) include neopentanediol, ethylene glycol, diethylene glycol, propylene glycol, dipropylene glycol, hydrogenated bisphenol A, 1,6-hexanediol, hydroxypivalylhydroxypivalate, cyclohexanedimethanol, 1,4-butanediol, 2-ethyl-1,3-hexandiol, 2,2,4-trimethyl-1,3-pentandiol, 2-ethyl-2-butyl-1,3-propanediol, 2-methyl-1,3-propanediol, and mixtures thereof. Preferred difunctional polyols (a) are neopentane diol and 2-ethyl-2-butyl-1,3-propanediol, with neopentane diol being most preferred.

The at least one trifunctional carboxylic acid (c) may be aromatic or aliphatic in nature, but aromatic containing structures are most preferred. Examples of suitable trifunctional carboxylic acids are trimellitic acid, 1,3,5-benzenetricarboxylic acid, citric acid, and mixtures thereof. Preferred trifunctional carboxylic acids are 1,3,5-benzenetricarboxylic acid and trimellitic acid, with trimellitic acid being most preferred.

Phosphoric acid (c) is as described above with respect to (I (d)).

Polymerization of the reactants (a), (b), and (c) may occur at typical esterification conditions, i.e., 200-230° C. reaction temperature while continuously removing water as a reaction by-product. Solvents that facilitate the removal of water from the reaction system (those that form an azeotrope) such as xylenes may be used. The reaction can also be subsequently admixed with suitable solvents.

Reactants (a), (b), and (c) will generally be used in a ratio of 6.3:3.0:0.05 to 7.9:4.0: 0.1 5, preferably from 6.7:3.2:0.07 to 7.6:3.8:0.12, and most preferably from 6.9:3.3:0.09 to 7.3:3.5:0.11.

A commercially available and most preferred example of compound (II) is LUBRIZOL™ 2063, available from the Lubrizol Corp of Wickliffe, Ohio.

Compound (I) will typically comprise from 50 to 80% by weight of the mixture of compound (I) and compound (II), preferably from 60 to 75% by weight, and most preferably from 65 to 70% by weight, based on the total weight of the mixture of compound (I) and compound (II). Compound (II) will comprise from 20 to 50% by weight of the mixture of compound (I) and compound (II), preferably from 25 to 40% by weight, and most preferably from 30 to 35% by weight, based on the total weight of the mixture of compound (I) and compound (II).

The composition comprising the mixture of compound (I) and compound (II) will typically be present in a coating composition in an amount of from 0.10 to 1.00% by weight, preferably from 0.10 to 0.30%, and most preferably from 0.15 to 0.25% by weight, based on the total nonvolatile weight of the coating composition.

The mixture of compound (I) and compound (II) may be incorporated into finished coating compositions by conventional mixing techniques using mixing equipment such as a mechanical mixer, a cowles blade, and the like. Although the additives may be added during the manufacturing process or subsequently to a finished coating, those skilled in the art will appreciate that in a most preferred embodiment, the additives will be added post grind during the manufacturing process. Although the mixture of compound (I) and compound (II) may be used in single or two component systems, use in two-component systems is preferred, particularly where the mixture of compounds (I) and (II) is placed in the resin component of a two component system.

Finally, although a variety of packaging options are suitable for coating compositions of the invention, it is most preferred that coating compositions containing the mixture of compounds (I) and (II) be packaged in epoxy or phenolic lined cans. Packaging in such containers has been found to ensure the retention of optimum adhesion characteristics.

In a most preferred embodiment of the coating compositions of the invention, the coating composition will be a two-component system with the reactive film forming polymer and the crosslinking agent combined shortly before application. In such an embodiment, the composition of the invention comprising the mixture of compounds (I) and (II) will be preferably incorporated with the film forming polymer containing component.

Component (II) may also comprise one or more solvents. In a preferred embodiment, component (II) will include one or more solvents. Suitable solvents and/or diluents include aromatics, napthas, acetates, ethers, esters, ketones, ether esters and mixtures thereof.

Additives, such as catalysts, pigments, dyes, leveling agents, and the like may be added as required to the coating compositions of the invention.

The coating compositions of the invention may be stored as such for prolonged periods at room temperature without gel formation or undesirable changes. These may be diluted as required to a suitable concentration and applied by conventional methods, for example, spraying or spread coating, and cured by exposure to ambient temperatures of from 70 to 75° F., (21.1° C.-23.88° C.), for a period of from 1 to 3 hours, preferably from 1.5 to 2 hours. However, sandable films of the coating compositions of the invention comprising mixtures of compounds (I) and (II) may also be obtained upon exposure of the applied coating to temperatures in the range of from at least 120° F. (48.88° C.), more preferably up to 140° F.(60° C.), for periods of from 30 to 50 minutes, preferably from 30 to 40 minutes.

The invention is further illustrated but is not limited by the following examples in which all parts and percentages are by weight unless otherwise specified.

### EXAMPLE 1

A coating composition (A) according to the invention was prepared as follows by the adding the identified amounts of compounds (I) and (II) to a urethane primer. Two additional coating compositions showing the respective effects of compounds (I) and (II) alone, i.e., (B) and (C) were also prepared. The resultant mixtures of the urethane primer, and compound (I) and/or compound (II) were shaken for 30 minutes on a Red Devil® paint shaker. The hardener and reducer components were stirred by hand as were the ready to spray mixtures of the combined primers, hardeners, and reducers.

| | | | | |
|---|---|---|---|---|
| Urethane Primer with ZnPhos | 100.0 | | 0.0 | 0.0 |
| Primer without ZnPhos ² | 0.0 | | 96.2 | 95.68 |
| ZCPP/SRPP | 0.0 | | 3.8 | 3.8 |
| Compound (I) ³ | 0.0 | | 0.0 | 0.28 |
| Compound (II) ⁴ | 0.0 | | 0.0 | 0.14 |
| Corrosion Inhibitor ⁵ | 0.0 | | 0.0 | 0.10 |
| Hardener ⁶ | 17.56 | g | 17.56 | 17.56 |
| Total | 117.56 | g | 117.56 | 117.56 |

A urethane primer based on a hydroxy functional acrylic and acrylated polyester resins similar to a commercially available product from BASF Corporation of Whitehouse, OH sold under the name 800K having zinc phosphate in the form of a pigment also sold by BASF under the name ZNP/S.
² A urethane primer based on a hydroxy functional acrylic and acrylated polyester resin identical to that of footnote #1
except the zinc phosphate is not included.
³ Borchigen HMP, commercially available from Wolff Walstrode, Bayer Corporation of Burr Ridge, IL.
⁴ LUBRIZOL ® 2063, commercially available from Lubrizol Corporation of Wickliffe, OH.
⁵ Irgacor 153, commercially available from Ciba-Geigy Corp. of Tarrytown, New York.
⁶ An isocyanate based crosslinking component commercially available as LH820 Hardener from BASF Corp.

### EXAMPLE 2

The coatings of Example 1 were applied to cold rolled steel panels (Q-Panel, R-412 (Steel, dull matte finish)), aluminum panels (Q-Panel, A-412 (aluminum, mill finish 3105 H24)), and galvanized steel (ACT labs, APR 18661(C) (ACT E60 E2G 60G 2 side). The sanded steel and cold rolled steel panels were sanded with 240-grit sandpaper. Approximately 4 mil of the coatings of Example 1 were applied to each panel using conventional spray equipment and cured for two hours at ambient temperature, followed by sanding with 400 grit sand paper. Approximately 1.0 mils of commercially available R-M™ Diamont™ Red basecoat* were then applied using conventional spray equipment. The basecoat was allowed to flash for 20 minutes, followed with the application of 3.0 mils of a urethane based clearcoat by high volume/low pressure (HVLP) spray application equipment. Panels) were allowed to air dry for seven days at ambient temperature (65-70° F.) (18.33° C.-21.11° C.).

*R-M and Diamont are registered trademarks of BASF. The red basecoat is commercially available from BASF Corporation of Whitehouse, OH as Diamont® Basecoat. The basecoat was mixed with BASF″s commercially available BCH2 hardener and UR-50 Reducer @4:1:1 by volume.

Salt Spray Testing Results-Corrosion Resistance Salt Spray Scribe Lifting Results mm of lift at scribe

Following preparation according to Example 2, panels were placed in a salt spray cabinet, where they were subjected to a spray of 5% salt in water solution for 96 hours. The panels were removed after 96 hours in the salt spray cabinet and the scribed line was first pressed with tape and pulled and then the scribe was probed with a Buck knife to determine the amount of material easily lifted from the scribe area.

The results for the Corrosion test showing amount of paint removed in millimeters (mm) , are set forth in Table 1. The percent reduction in scribe corrosion in comparison to the Control Coating A are set forth in Table 2.

TABLE 1
Corrosion Test Result

| | Coating A (Control) | Coating B | Coating C |
|---|---|---|---|
| | Amount of | Material | Removed in mm |
| Cold Rolled Steel | 18 | 9 | 7 |
| Galvanized | 8 | 6 | 5 |
| Aluminum | 5 | 4 | 3 |

TABLE 2
Reduction in Scribe Corrosion compared to Control Coating A

| | | Coating C |
|---|---|---|
| | Coating B | Reduction over |
| Substrate | % Corrosion | Control (A) |
| Cold Rolled Steel | 50% | 61% |
| Galvanized | 25% | 37% |
| Aluminum | 20% | 40% |

Adhesion Results:

Results show that adhesion was comparable for the panels coated with the control and panels coated with the coating of the present invention over the various substrates. Following preparation according to Example 2, panels were allowed to air dry for 6 days at ambient temperature (65-70 degrees F.) (18.33° C.-21.11° C.). Initial adhesion tests were conducted after the six-day drying time and values are recorded in Table 1 below.

After the six day drying period, the prepared panels were placed in a 100% Relative Humidity test @100° F. (37.77° C.) for 96 hours. Adhesion results following humidity exposure are recorded in Table 2.

Many coatings benefit from allowing the coating to “recover” from the stress of humidity testing but many coating never recover from such tests. An important measure of a coating″s resiliency is its ability to recover any adhesion lost during these periods of stress.

Table 3 shows the adhesion “recovery” for these experiments 4 days after humidity testing.

Adhesion was measured with the GM X adhesion test, i.e., an X is cut through the paint layers down to the substrate using a utility knife, and the ratings are as follows:

GM 10=no peeling during the tape pull.

GM 9=5% loss

GM 8=10% loss

GM 7=15% loss

GM 6=30% loss

GM 5=45% loss

GM 4=60% loss

GM 3=85% loss

GM 2=100% loss at the tape contact area

GM1=>100% loss (beyond tape contact area)

TABLE 1
Initial Adhesion Results - GM X Rating

| | Coating A | Coating B | Coating C |
|---|---|---|---|
| Cold Rolled Steel | 9 | 9 | 10 |
| Galvanized | 8 | 9 | 9 |
| Aluminum | 9 | 9 | 10 |

TABLE 2
96 hour Humidity Adhesion Results - GM X Rating

| | Coating A | Coating B | Coating C |
|---|---|---|---|
| Cold Rolled Steel | 8 | 9 | 9 |
| Galvanized | 7 | 7 | 8 |
| Aluminum | 6 | 6 | 5 |

TABLE 3
Recovery Results (4 days after humidity testing) - GM X Rating

| | Coating A | Coating B | Coating C |
|---|---|---|---|
| Cold Rolled Steel | 9 | 9 | 9 |
| Galvanized | 8 | 9 | 9 |
| Aluminum | 8 | 9 | 9 |

1] A two component coating composition for preventing corrosion of a metallic substrate, the composition comprising:
a) a film-forming component comprising a film-forming polymer and a crosslinking agent, wherein the film-forming polymer has functional groups selected from the group consisting of active hydrogen containing groups, epoxide groups, and mixtures thereof, and the crosslinking agent have functional groups selected from the group consisting of isocyanate groups and amine groups,
b) a corrosion protection component consisting essentially of compounds selected from the group consisting of zinc oxide, zinc phosphate, basic zinc phosphate, zinc nitrophophthalate, zinc molybdate, basic zinc phosphate hydrate, basic zinc molybdate, zinc benzoate and zinc salt of an organic nitro compound such as those sold under the trademark Heucorin RZ, calcium molybdate, calcium metaborate, barium metaborate, calcium strontium phosphosilicate, aluminum triphosphate, aluminum zinc phosphate, and zinc calcium aluminum strontium polyphosphate silicate and strontium aluminum polyphosphate and mixtures thereof, and
c) a component comprising (I) a first compound having an acid number of from 70 to 120 mg KOH/g, a hydroxyl number of from 200 to 400 mg KOH/g, a number average molecular weight of from 150 to 3000, and which is the reaction product of (a) at least one difunctional carboxylic acid, (b) at least one trifunctional polyol, (c) at least one chain stopper, and (d) phosphoric acid, and (II) a second compound comprising one or more carboxy phosphate esters having the formula: (R—O)ₓ—P(O)—(OM)_{3-X}
wherein M is hydrogen, metal or ammonium, x is a number from 0 to 3, and R is a saturated or unsaturated C₅-C₄₀ aliphatic group in which one or more of the aliphatic carbon atoms can be substituted or replaced with a halogen atom (such as fluorine or chlorine), a C₁-C₆ alkyl group, a C₁-C₆ alkoxy group, a C₆-C₁₀ aromatic hydrocarbon group, preferably phenyl or naphthyl, or a C₆-C₁₀ aromatic hydrocarbon group that is substituted with one or more (preferably 1 to 3) C₁ -C₆ alkyl groups or —COOR¹ groups wherein R¹ is H, metal, ammonium, C₁-C₆ alkyl, or C₆-C₁₀ aryl, or mixtures thereof,
wherein said coating demonstrates at least a 20% reduction in salt spray corrosion-over the same coating without components (b) and (c).

2] A composition according to claim 1, wherein corrosion protection component (b) is present in an amount between 0.1 and 20% by weight, based on total coating composition weight.

3] A composition according to claim 1, wherein the corrosion protection component (b) is selected from the group consisting of zinc calcium aluminum strontium polyphosphate, strontium aluminum polyphosphate silicate and mixtures thereof.

4] A composition according to claim 3, wherein the pigments are present in a mixture in a ratio of between 70:30 and 30:70 of zinc calcium aluminum strontium polyphosphate to strontium aluminum polyphosphate silicate, respectively.

5] A composition according to claim 1 wherein second compound (II) has an acid number of from 50 to 200 mg KOH/g, a hydroxyl number of from 100 to 250 mg KOH/g, a number average molecular weight of from 600 to 1200 and is the reaction product of (a) at least one difunctional polyol, (b) phosphoric acid, and (c) at least one trifunctional carboxylic acid.

6] A composition according to claim 1 wherein compound (I) comprises the reaction product of components (a), (b), (c), and (d) reacted in a molar ratio of from 4.2: 4.9:0.01:0.0005 to 5.1 :5.6:0.7:0.005.

7] A composition according to claim 1 wherein compound (I) comprises an acid number of from 70 to 100 mg KOH/g, a hydroxyl number of from 300 to 400 mg KOH/g, a number average molecular weight of from 400 to 600.

8] A composition according to claim 1 comprising from 50 to 80% by weight of compound (I) and from 20 to 50% by weight of compound (II), based on the total weight of the mixture of compound (I) and compound (II).

9] A composition as claimed in claim 5 comprising from 60 to 75% by weight of compound (I) and from 25 to 40% by weight of compound (II), based on the total weight of the mixture of compound (I) and compound (II).

10] A composition as claimed in claim 1 wherein the cured coating composition demonstrates
the at least one difunctional carboxylic acid (Ia) is selected from the group consisting of adipic acid, azeleic acid, fumaric acid, phthalic acid, sebacic acid, maleic acid, succinic acid, isophthalic acid, tetrahydrophthalic acid, hexahydrophthalic acid, dimer fatty acids, itaconic acid, glutaric acid, cyclohexanedicarboxylic acid, and mixtures thereof, the at least one trifunctional polyol (Ib) is selected from the group consisting of trimethylolpropane, trimethylol ethane, glycerin, 1,2,4-butanetriol, and mixtures thereof, and
the at least one chain stopper (Ic) is selected from the group consisting of para-t-butyl benzoic acid, benzoic acid, salicylic acid, 2-ethylhexanoic acid, pelargonic acid, isononanoic acid, C₁₈ fatty acids, stearic acid, lauric acid, palmitic acid, and mixtures thereof.

11] A composition as claimed in claim 5 wherein the at least one difunctional polyol (IIa) is selected from the group consisting of neopentanediol, ethylene glycol, diethylene glycol, propylene glycol, dipropylene glycol, hydrogenated bisphenol A, 1,6-hexanediol, hydroxypivalylhydroxypivalate, cyclohexanedimethanol, 1,4-butanediol, 2-ethyl-1,3-hexandiol, 2,2,4-trimethyl-1,3-pentandiol, 2-ethyl-2-butyl-1,3-propanediol, 2-methyl-1,3-propanediol, and mixtures thereof, and the at least one trifunctional carboxylic acid (IIc) is selected from the group consisting of trimellitic acid, 1,3,5-benzenetricarboxylic acid, citric acid, , and mixtures thereof.

12] A composition as claimed in claim 11 wherein the at least one difunctional carboxylic acid (Ia) is adipic acid, the at least one trifunctional polyol (Ib) is trimethyolopropane and the at least one chain stopper (Ic) is para-t-butyl benzoic acid.

13] A composition as claimed in claim 11 wherein the at least one difunctional polyol (IIa) is neopentanediol and the at least one trifunctional carboxylic acid (IIc) is trimellitic acid.

14] A composition as claimed in claim 11 comprising from 0.10 to 1.00% by weight of the mixture of compounds (I) and (II), based on the total nonvolatile weight of the coating composition.

15] A composition as claimed in claim 1 wherein the film forming binder is comprised of an acrylic resin and an isocyanate functional crosslinking agent.

16] A composition as claimed in claim 1 which is a primer composition.

17] A composition as claimed in claim 1 wherein the cured coating on a substrate demonstrates improved corrosion resistance in comparison to a coating.

18] A method of improving corrosion resistance in a multilayer coating system, comprising
applying a primer coating composition directly to a metal substrate, the primer coating composition comprising:
a) a film-forming component comprising a film-forming polymer and a crosslinking agent, wherein the film-forming polymer has functional groups selected from the group consisting of active hydrogen containing groups, epoxide groups, and mixtures thereof, and the crosslinking agent have functional groups selected from the group consisting of isocyanate groups and amine groups, and
b) a corrosion protection component consisting essentially of compounds selected from the group consisting of zinc oxide, zinc phosphate, basic zinc phosphate, zinc nitrophophthalate, zinc molybdate, basic zinc phosphate hydrate, basic zinc molybdate, zinc benzoate and zinc salt of an organic nitro compound such as those sold under the trademark Heucorin RZ, calcium molybdate, calcium metaborate, barium metaborate, calcium strontium phosphosilicate, aluminum triphosphate, aluminum zinc phosphate, and zinc calcium aluminum strontium polyphosphate silicate and strontium aluminum polyphosphate, calcium aluminum strontium polyphosphate silicate hydrate, a modified strontium aluminum polyphoshate hydrate, (2-benzothiozolythio)-succinic acid amine salt and mixtures thereof, present in the composition in an amount effective to prevent corrosion of the substrate, and
c) a composition comprising (I) a first compound having an acid number of from 70 to 120 mg KOH/g, a hydroxyl number of from 200 to 400 mg KOH/g, a number average molecular weight of from 150 to 3000, and which is the reaction product of (a) at least one difunctional carboxylic acid, (b) at least one trifunctional polyol, (c) at least one chain stopper, and (d) phosphoric acid, and (II) a second compound comprising one or more carboxy phosphate esters having the formula: (R—O)ₓ—P(O)—(OM)_{3-X} wherein M is hydrogen, metal or ammonium, x is a number from 0 to 3, and R is a saturated or unsaturated C₅-C₄₀ aliphatic group in which one or more of the aliphatic carbon atoms can be substituted or replaced with a halogen atom (such as fluorine or chlorine), a C₁-C₆ alkyl group, a C₁-C₆ alkoxy group, a C₆-C ₁₀ aromatic hydrocarbon group, preferably phenyl or naphthyl, or a C₆-C₁₀ aromatic hydrocarbon group that is substituted with one or more (preferably 1 to 3) C₁-C₆ alkyl groups or —COOR¹ groups wherein R¹ is H, metal, ammonium, C₁-C₆ alkyl, or C₆-C₁₀ aryl, or mixtures thereof, curing the coating to provide a primed metallic substrate, and applying to the primed metallic substrate one or more additional coating compositions, and curing the one or more additional coating compositions to provide a cured multilayer coating system, wherein said coating system demonstrates at least a 20% reduction in salt spray corrosion over the same coating without components (b) and (c).
